(19) United States
(12) Patent Application Publication
(10) Pub. No.: US 2008/0109130 A1
(43) Pub. Date: May 8, 2008

(54) Remote Vehicle Diagnosis System

(76) Inventor: Chung-Yi HUANG, Taichung City (TW)

Correspondence Address: Dr. BANGER SHIA, 102 Lindencrest Ct., Sugar Land, TX, 77479-5201, US

(21) Appl. No.: 11/925,928

(22) Filed: Oct. 27, 2007

(30) Foreign Application Priority Data
Nov. 8, 2006 (TW) 095141402

(51) Int. Cl. G01M 17/00; G06F 19/00

(52) U.S. Cl. 701/33

(57) ABSTRACT

A remote vehicle diagnosis system comprises an electronic control unit, a signal transmitter, a first network communicator, a second network communicator, a signal reproducer/learner and a diagnosis instrument. The electronic control unit, the signal transmitter and the first network communicator are connected to each other by line. The first network communicator and the second network communicator are connected to each other via signals. The second network communicator, the signal reproducer/learner and the diagnosis instrument are connected to each other by line. By such arrangements, the diagnosis instrument can directly and remotely control the signal parameter adjustment of the electronic control unit, thus improving the working efficiency of the electronic control unit.

### BACKGROUND OF THE INVENTION

1. Field of the Invention

The present invention relates to a vehicle diagnosis system, and more particularly to a remote vehicle diagnosis system.

2. Description of the Prior Art

With the rapid development of the technology, people have gradually substituted vehicle for walking. However, the development of the technology has been increasing the consumption of the finite energy source, thus developing a vehicle electronic control system 10. The vehicle electrical control system 10 comprises an electronic control unit (ECU) 11 and a diagnosis instrument 12.

The ECU 11 includes a discrete input module, a frequency input module, an analog input module, a pulse width modulation output module, a frequency output module, a switch output module, a communication link module and a power control module, so that the ECU 11 can compute various state signals transmitted from the engine and send control signals to control respective actuators.

The diagnosis instrument 12 and the ECU 11 are connected via signals to adjust and amend the parameters of ECU 11. However, this kind of vehicle electrical control system has the following problems:

The ECU 11 and the diagnosis instrument 12 are researched and developed by respective vehicle producers, so the vehicle producers own exclusive diagnosis instrument 12 used together with the ECU 11. However, in order to ensure the trade secrets and the technology protection, the diagnosis instruments 12 are under the strict management and control of the producers and can only be obtained by dealing with the producers, thus relatively increasing the purchase cost of the consumer. Moreover, since the technology of operation and maintenance is also under the control of the producers, the operational difficulty is thus increased.

The present invention has arisen to mitigate and/or obviate the afore-described disadvantages.

### SUMMARY OF THE INVENTION

The primary objective of the present invention is to provide a remote vehicle diagnosis system capable of reducing the purchase cost of the diagnosis instrument and the technical difficulty of the diagnosis instrument.

In order to achieve the above objective, the remote vehicle diagnosis system of the present invention utilizes a signal transmitter, a first network communicator, a second network communicator and a signal reproducer/learner to make the technical operator remotely and directly control the optimization adjustment of the signal parameters of the electronic control unit. Thereby, it is easy to amend and set the signal parameters according to the requirements, without being limited to the original factory technology, thus not only reducing the purchase cost of the diagnosis instrument and the technical difficulty of the diagnosis instrument, but saving the time of going to the vehicle factory for maintenance.

### BRIEF DESCRIPTION OF THE DRAWINGS

FIG. 1 is a block diagram of a conventional vehicle electrical control system; and

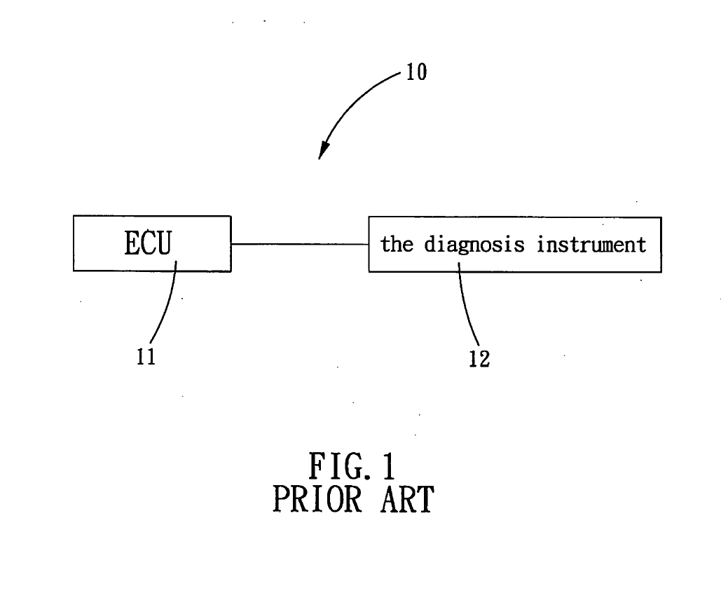

FIG. 2 is a block diagram of a remote vehicle diagnosis system in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

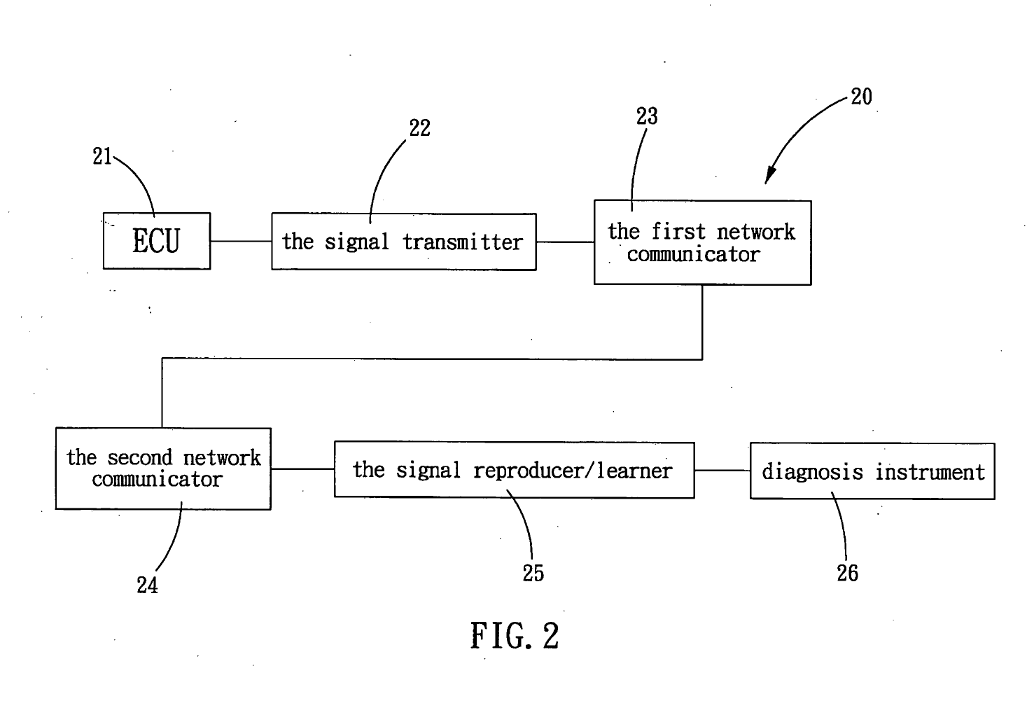

Referring to FIG. 2, a remote vehicle diagnosis system 20 in accordance with a preferred embodiment of the present invention comprises an electronic control unit (ECU) 21, a signal transmitter 22, a first network communicator 23 and a second network communicator 24, a signal reproducer/learner 25 and a diagnosis instrument 26.

The ECU 21 includes a discrete input module, a frequency input module, an analog input module, a pulse width modulation output module, a frequency output module, a switch output module, a communication link module and a power control module.

The signal transmitter 22 is connected to the ECU 21 by line.

The first network communicator 23 is connected to the signal transmitter 22 by line.

The second network communicator 24 and the first internet communicator 23 are connected via signals through a TCP/IP (Transmission Control Protocol/Internet Protocol) network architecture to make the first network and the second network communicators 23, 24 be set with the communication protocols according to the vehicle factories and make the first and the second network communicators 23, 24 perform the bidirectional transmission.

The signal copying/learning device 25 is connected to the second network communicator 24 by line.

The diagnosis instrument 26 is connected to the signal reproducer/learner 25 by line. Due to the limitation of diagnosis or measuring the ECU 21, the diagnosis instrument 26 must be replaced with a new one, so that the internal software of the signal transmitter 22, the first network communicator 23, the second signal communicator 24 and the signal reproducer/learner 25 must be correspondingly replaced for transmission.

The aforementioned is the summary of the positional and structural relationship of the respective components of the preferred embodiment in accordance with the present invention.

For a better understanding of the present invention, its operation and function, reference should be made to FIG. 2 again:

The ECU 21, the signal transmitter 22 and the first network communicator 23 of the present invention are disposed on a vehicle, and the second network communicator 24, the signal reproducer/learner 25 and the diagnosis instrument 26 are disposed at a fixed position. The ECU 21 is used to receive various state signals from the engine and synchronously compute the signals, so that the ECU 21 will send control signals to control the action of the respective actuators and transmit the feedback signal parameters generated by the ECU 21 to the signal reproducer/leaner 25 through the first and the second network communicators 23, 24. The signal reproducer/learner 25 is used to simulate the signal parameters of ECU 21, and then transmit the signal parameters to the diagnosis instrument 26. The diagnosis instrument 26 is used to detect the feedback signal parameters which are generated by the ECU 21 detecting the checking the respective actuators.

After detecting and checking the signal parameters, the diagnosis instrument 26 will send command signals. These command signals will be returned back by the signal reproducer/learner 25 through the first and the second network communicator 23, 24, so that the signal reproducer/learner 25 can utilize the returned signals to achieve the study objective and make the first and the second network communicators 23, 24 transmit the returned signals to the ECU 21. By such arrangements, the technical operator can utilize the diagnosis instrument 26 to remotely amend and set ECU 21 without any difficulty, so as to adjust the signals of the fuel supply system (fuel supply, fuel filtering, pressure adjustment, and fuel injection systems, etc), the air intake system (filtering, metering, adjusting, distributing), the control system (ECU, sensor, executive components), the ignition system (ignition signal generator, ignition device, ignition coil), etc.

To summarize, a remote vehicle diagnosis system of the present invention comprises an ECU, a signal transmitter, a first network communicator, a second network communicator, a signal reproducer/learner and a diagnosis instrument. Between the ECU and the diagnosis instrument of the remote vehicle diagnosis system are disposed the signal transmitter, the first network communicator, the second network communicator and the signal reproducer/learner to make the diagnosis system not limited to the original factory technology. By such arrangements, it is easy for the technical operator to amend and set the ECU parameter signals through the diagnosis instrument, thus reducing the purchase cost and the operational difficulty.

While we have shown and described various embodiments in accordance with the present invention, it is clear to those skilled in the art that further embodiments may be made without departing from the scope of the present invention.

What is claimed is:

1. A remote vehicle diagnosis system comprising: an electronic control unit, a signal transmitter, a signal reproducer/learner and a diagnosis instrument, the electronic control unit being disposed on a vehicle to cooperate with the diagnosis instrument, and the electronic control unit and the diagnosis instrument being controlled by a vehicle factory, the remote vehicle diagnosis system is characterized in that:
the signal transmitter is connected to the electronic control unit to transmit and receive a signal parameter;
the signal reproducer/learner is connected to the signal transmitter and used to perform a signal parameter simulation during a forward transmission and perform a signal parameter learning during a backward transmission; and
the diagnosis instrument is connected to the signal reproducer/learner to directly and remotely control the electronic control unit to perform a parameter adjustment.

2. The remote vehicle diagnosis system as claimed in claim 1 further comprising:
a first network communicator being connected to the signal transmitter;
a second network communicator being connected to the signal reproducer/learner and the first network communicator, respectively.

3. The remote vehicle diagnosis system as claimed in claim 2, wherein the first network communicator and the second network communicator are connected through a TCP or IP (Transmission Control Protocol/Internet Protocol) network architecture.
